(19) United States
(12) Patent Application Publication
(10) Pub. No.: US 2024/0140622 A1
(43) Pub. Date: May 2, 2024

(54) PASSIVE THERMAL RADIATOR STRUCTURE

(71) Applicant: Maxar Space LLC, Westminster, CO (US)

(72) Inventor: Michael Freestone, Woodside, CA (US)

(73) Assignee: Maxar Space LLC, Westminster, CO (US)

(21) Appl. No.: 17/979,579

(22) Filed: Nov. 2, 2022

Related U.S. Application Data
(60) Provisional application No. 63/421,080, filed on Oct. 31, 2022.

(51) Int. Cl. B64G 1/50; F28D 15/02

(52) U.S. Cl. CPC B64G 1/503; B64G 1/506; F28D 15/0275; F28D 15/0283; F28D 2015/0216; F28D 2021/0021

(57) ABSTRACT

A radiator structure for a satellite is provided. A first radiator panel adapted to be positioned on a first side of a central body, and a second radiator panel adapted to be positioned on a second side of the central body. Other implementations include a third radiator panel positioned on a third side of the central body. The apparatus also includes at least one heat pipe embedded between a first face and a second face of each radiator panel and extending from the first radiator panel through the first radiator panel and through the second radiator panel. The heat pipe structurally supports the first radiator panel and the second radiator panel relative to the intermediate radiator panel. A method of manufacturing a radiator structure is also provided.

### CLAIM OF PRIORITY

This application claims priority to U.S. Provisional Patent Application No. 63/421,080, entitled “PASSIVE THERMAL RADIATOR STRUCTURE”, filed Oct. 31, 2022, which application is incorporated by reference herein in its entirety.

### BACKGROUND

The present disclosure relates to satellite technology.

Satellites are widely used for a variety of purposes including communication, location, and data gathering (e.g., directing sensors at the Earth including cameras, radar, laser, or other sensors). Different satellites may include different equipment according to the functions they are to fulfill. Satellites may be placed in orbit at different heights above the Earth and may be adapted for the location at which they are expected to operate. In order to fulfill their functions, satellites may carry equipment which generates significant heat which may be problematic. If heat is not adequately managed, the temperature of satellite components may rise to unacceptable levels, which may affect operation. Managing heat in space is generally more challenging than other environments (e.g., on or under land, in air, or in water). Designing a satellite to accommodate heat generating components it may generate while minimizing costs and resources such as mass and size is a challenging task.

When orbiting a body, a satellite may have a main body with North (N), South (S), East (E), and West (W) sides, labeled according to the general direction toward which its normal vector is oriented when the satellite is on-orbit. Radiator panels may be disposed on one or more of the sides to dissipate heat from heat generating components in the satellite.

### BRIEF DESCRIPTION OF THE DRAWINGS

FIG. 1 is a block diagram depicting a satellite including a bus and payload.

FIG. 2 shows an example of a satellite including solar panels and antennas extending from a central body.

FIG. 3 shows an example of mounting heat generating components in a central body.

FIG. 4 shows an example of a central body having a cubic shape with six sides.

FIG. 5 illustrates a basic embodiment of a radiator system.

FIG. 6 illustrates a top view prior art version of a radiator system.

FIG. 7 illustrates a top view of a radiator system in accordance with the present disclosure.

FIG. 8 illustrates a plan view of one embodiment of a radiator system during manufacture.

FIG. 9 illustrates an end view of the radiator system during manufacture.

FIG. 10 illustrates a plan view of one embodiment of a radiator system during manufacture.

FIGS. 11A and 11B illustrate a bending process for the radiator system.

FIGS. 12A and 12B illustrate the bending process from a different perspective than FIGS. 11A and 11B.

FIG. 13 illustrates another embodiment of a radiator system.

FIG. 14 illustrates another example of a satellite.

FIG. 15 illustrates another example of a radiator system.

FIG. 16 illustrates an example of a large-scale radiator system having an extension.

FIG. 17 is a cross-section along line 17-17 in FIG. 16.

FIG. 18 is a flow chart illustrating a method of manufacturing a radiator system.

### DETAILED DESCRIPTION

Aspects of the technology may be applied to satellites used for various purposes. In many satellites, significant heat may be generated by electronic components which provide the intended functions of the satellite. Such heat-generating components may be attached to radiator panels in a manner that enables efficient heat transfer from heat-generating components to radiator panels from which it is radiated into space.

In order to reduce the impact that thermal dissipation components have on the weight, thermal efficiency, complexity and number of parts of satellites, a radiator structure is provided whereby radiator panels are thermally and structurally coupled together using embedded heat pipes with minimal exposed portions between the panels thermal coupling which is exposed to an exterior of a satellite. The radiators may share the thermal load and may be positioned on various types of satellite structures. The technology described herein provides a three-dimensional radiator system which eliminates or greatly reduces the need for external thermal coupling between panels of a spacecraft radiator. Thus, a radiator structure may include a first radiator panel, a second radiator panel, and an intermediate radiator panel with embedded heat pipes, embedded between a first face and a second face of each panel, and extending into the intermediate radiator panel. The embedded heat pipes both thermally and structurally support the first radiator panel and the second radiator panel relative to the intermediate radiator panel.

Aspects of the technology may be implemented in a single satellite or in multiple satellites (e.g., in a satellite communication system). A satellite communication system may include a single satellite or a constellation of geostationary or non-geostationary satellites orbiting the Earth, a plurality of gateways and a plurality of subscriber terminals (also referred to as terminals).

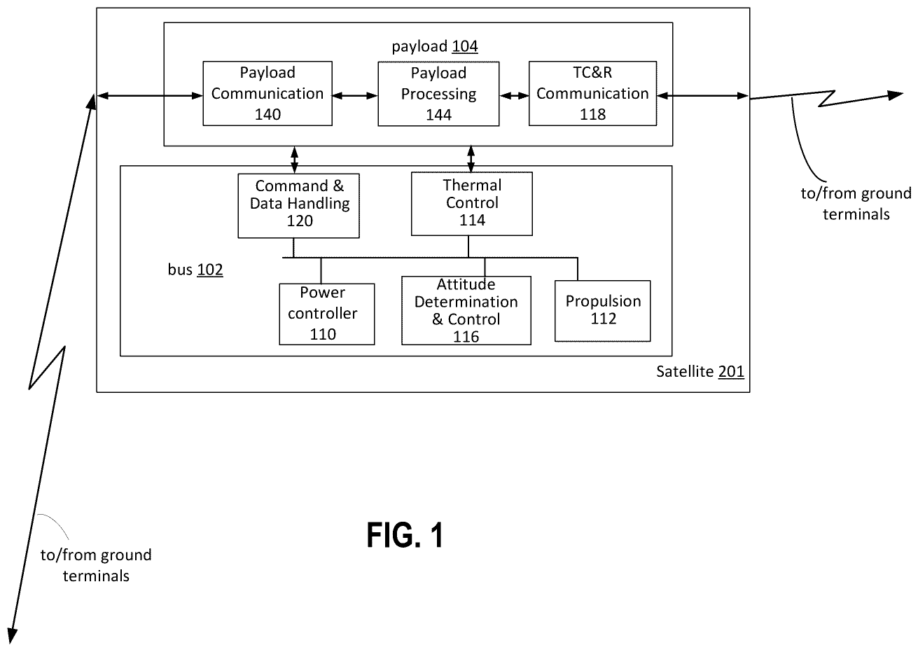

FIG. 1 is a block diagram of one embodiment of satellite 201. In one embodiment, satellite 201 includes a bus 102 and a payload 104 carried by bus 102. Some embodiments of satellite 201 may include more than one payload. The payload provides the functionality of the communication and/or processing systems described herein.

In general, bus 102 is the spacecraft that houses the payload. For example, the bus components include a power controller 110, which may contain solar panels and one or more batteries (not shown in FIG. 1) to provide power to other satellite components; propulsion 112; thermal control 114; attitude determination and control 116; telemetry command and data handling (T, C & R communication) 118; and command and data handling 120. Other equipment can also be included. Solar panels and batteries within the power controller 110, are used to provide power to satellite 201. Thrusters and propellent within propulsion 112 are used for changing the position or orientation of satellite 201 while in space. Attitude sensors within attitude determination & control 116 are used to determine the position and orientation of satellite 201. System processor(s) within control and data handling 120 is used to control and operate satellite 201. An operator on the ground can control satellite 201 by sending commands via T, C & R communication 118, and processing equipment 118 to be executed by control and data handling 120. Some embodiments include a Network Control Center that wirelessly communicates with T, C & R communication, and processing equipment 118 to send commands and control satellite 201. In one embodiment, control and data handling 120 and T, C & R communication, and processing equipment 118 are in communication with payload 104. In general, electronic components of bus 102 (e.g., processor 120, T, C & R communication, and processing equipment 118, payload 104, and power controller 110) generate heat (e.g., due to resistive heating effects) and will be maintained and controlled by the thermal control within acceptable temperature ranges. The technology described herein may be applied to any type of satellite in which the instruments, payload or any spacecraft hardware generates heat in space.

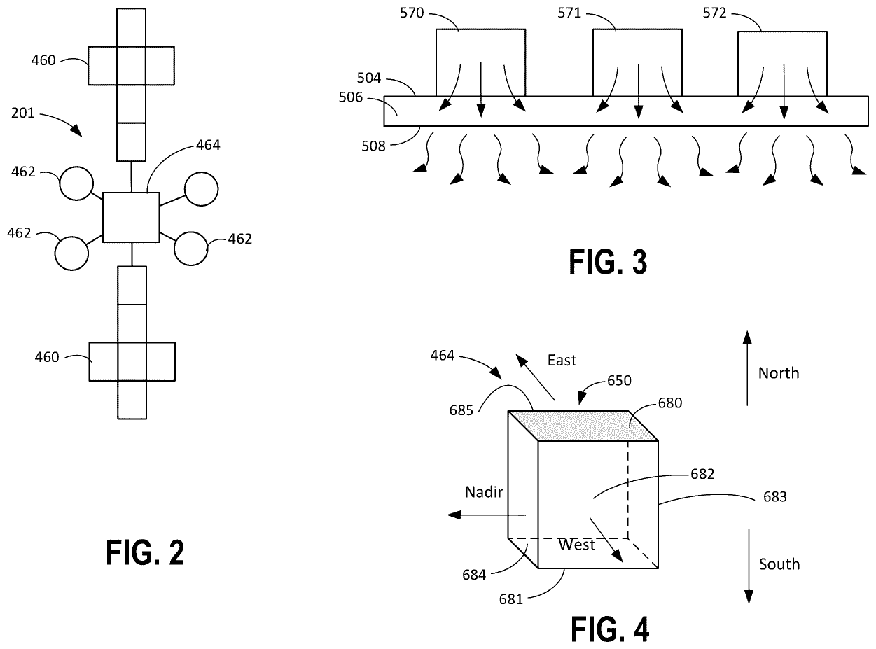

FIG. 2 illustrates an example of satellite 201 that includes solar panels 460 and antennas 462 extending from a central body 464. In general, satellite bus and payload components may be located together in such a central body. In some cases, a central body may include one or more radiator panels to radiate heat generated by heat-generating components.

FIG. 3 shows an example of mounting of heat generating components in central body 664 of satellite 201. Heat-generating components 570, 571, 572 are attached to a first surface 504 of a radiator panel 506 so that heat generated in heat-generating components 570-572 can easily flow into radiator panel 506, where it is dispersed laterally and can be radiated into space from a second surface 508 of radiator panel 506 (as illustrated by wavey arrows).

FIG. 4 shows an example of a central body 464 having a cubic shape with six sides 680-685 that includes a radiator panel on the north facing side 680 of central body 664. Each side 680-685 is labeled according to the general direction toward which its normal vector is oriented when the satellite is on-orbit about an orbital body. Ones of the six sides of the central body may be referred to as a first or North (N) side 680, a second or South (S) side 681, a third or East side (E) 685, and a fourth or West side (W) 682, all of which are disposed between, and orthogonal to, a fifth side or a forward side 684 (generally disposed in the nadir direction to an orbital body) and a sixth side or aft side 683 (generally disposed in the zenith direction relative to a body orbited by the satellite). Each of the sides may also be referred to as panels, side panels, sides, or surfaces. For example, an on-orbit satellite is generally oriented such that normal vectors drawn from the N panel and the S panel are in substantial alignment with the N-S axis of the Earth, with the N panel facing North and the S panel facing South, and such that the normal vectors drawn from the E panel and the W panel are in substantial alignment with the E-W direction of the Earth.

North side 680 and south side 681 may be suitable for radiating heat because they are generally not facing the sun so that any radiated heat from the sun hits them obliquely at a low angle and does not cause substantial heating. In an example, radiator panels are provided along surfaces of both north side 680 and south side 681. Other sides such as west side 682 or forward (nadir) 684 may be subject to radiated heat from the sun at angles close to ninety degrees at certain times. Typically, east 685 and west 682 facing sides of the satellite offer limited thermal dissipation capability due to the high incident solar load on those surfaces. In accordance with the technology, the east and west facing sides may be used to mount and dissipate the thermal load caused by heat generating components such as RF loads, feeds, switches, circulators, and multiplexers (OMUXs), which can withstand temperatures higher than normal payload electronics equipment.

The technology herein includes satellites wherein the thermal radiators on respective, north/south and/or east/west opposing sides are thermally coupled together using an intermediate radiator panel, with heat pipes embedded in each radiator panel and serving to structurally connect the opposing side radiators to the intermediate radiator. The resulting three-dimensional passive thermal radiator structure reduces the number of additional parts (such as jumper heat pipes and longeron structural connections currently used in radiator structures. In addition, the three-dimensional passive thermal radiator structure is more efficiently manufactured, eliminating a number of steps in a conventional radiator manufacturing operation.

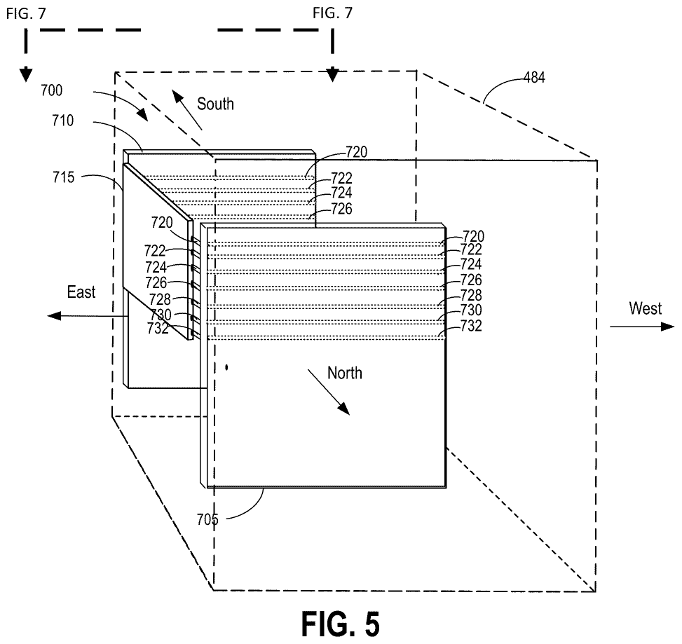

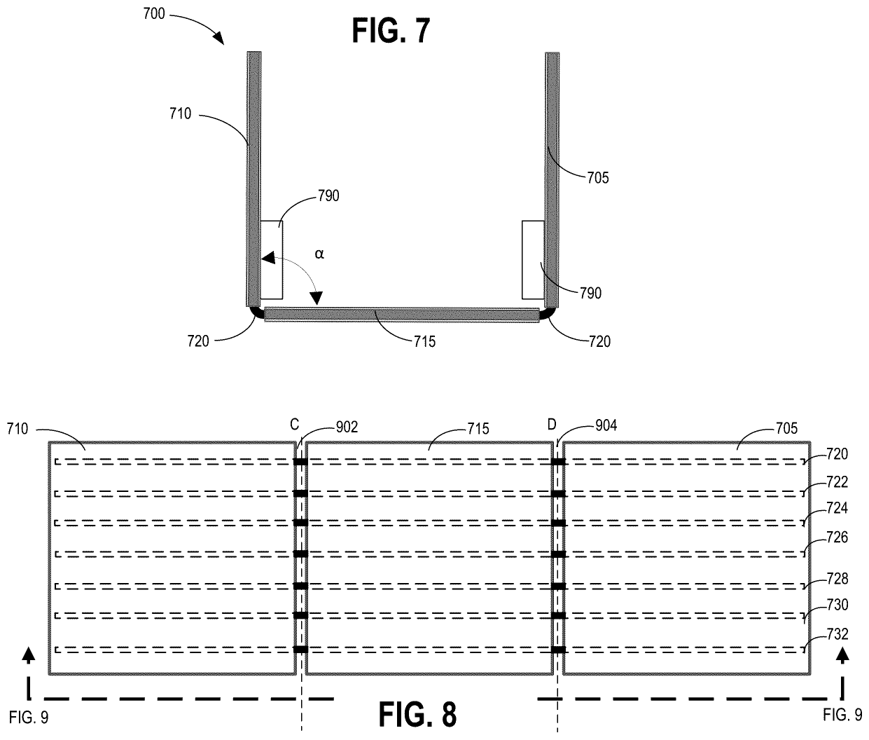

FIG. 5 illustrates a first embodiment of a radiator system 700 comprising a pair of radiator panels—a first or north radiator panel 705 and a second or south radiator panel 710, which are joined by an intermediate or east radiator panel 715. Each panel 705, 710, 715 may be configured to be attached to a respective north, south or east facing side (or other sides of a GEO or LEO satellite) of central body 484. Each panel 705, 710, 715 includes one or more embedded heat pipes 720, 722, 724, 726, 728, 730, 732 (only some of which are shown in FIG. 5) in each of panels 705, 710, 715. Intermediate radiator panel 715 is connected to the first radiator panel 705 and second radiator panel 710 by embedded heat pipes 720, 722, 724, 726, 728, 730, 732. Heat dissipating equipment (790, illustrated in FIG. 7) may be mounted on each of the radiator panels. Although the radiator panels 705, 710, 715 (and other radiator panels herein) are illustrated as generally rectangular, it should be understood that the panels may take any number of shapes and the technology described herein is not limited to radiator panels of any particular shape.

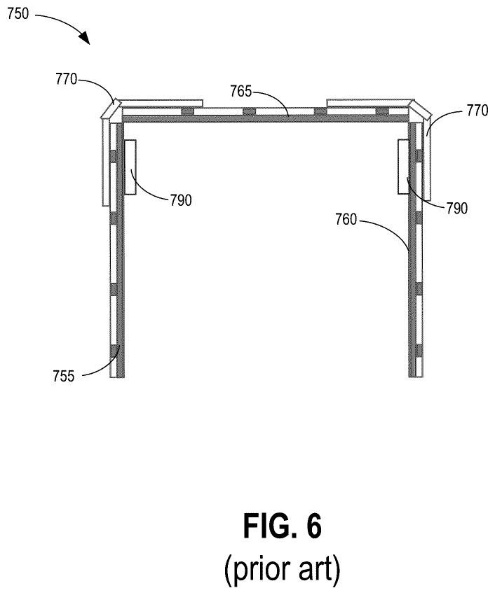

FIG. 6 is a top view of a conventional radiator structure 750. A conventional radiator structure 750 which includes a north radiator panel 755, a south radiator panel 760 and east radiator panel 765 also includes heat dissipation elements 790 coupled to the north radiator panel 755 and south radiator panel 760. The north radiator panel 755, south radiator panel 760 and east radiator panel 765 are connected by heat conducting jumpers 770 which are arranged to overlap a portion of each panel. Each jumper is connected either internally or externally to the radiator panels such that heat pipes within each panel transfer thermal energy to adjacent panels through the jumpers. This embodiment adds additional thermal interfaces through which the heat must travel and creates “delta-T” through each connection rendering the system less efficient. In embodiments, there is a change of approximately 5 degrees at each jumper interface and overlapping the interface of the jumper and each panel results in an increase in mass and assembly times.

FIG. 7 is a top view of radiator structure 700 of FIG. 5. As illustrated in FIG. 7, heat pipes (of which only heat pipe 720 is illustrated in FIG. 8) are embedded into each panel 705, 710, 720. The embedded heat pipes form the structural support and continue thermal coupling for heat transfer between the panels and the heat dissipating elements 790. In embodiments, a first radiator panel (i.e. panel 705) on a first side of a central body of the satellite is connected to an intermediate panel (i.e. panel 715), and a second radiator panel (i.e. panel 710) on a second side of the central body is likewise connected to an intermediate panel with structural support provided by the embedded heat pipes 720-732. Thus, the embedded (and partially exposed) heat pipes 720-732 provide sufficient structural support for the panels 705, 710, 720 of radiator structure 700 without the need for external support structure and without the need for additional thermal transport structures between adjacent panels.

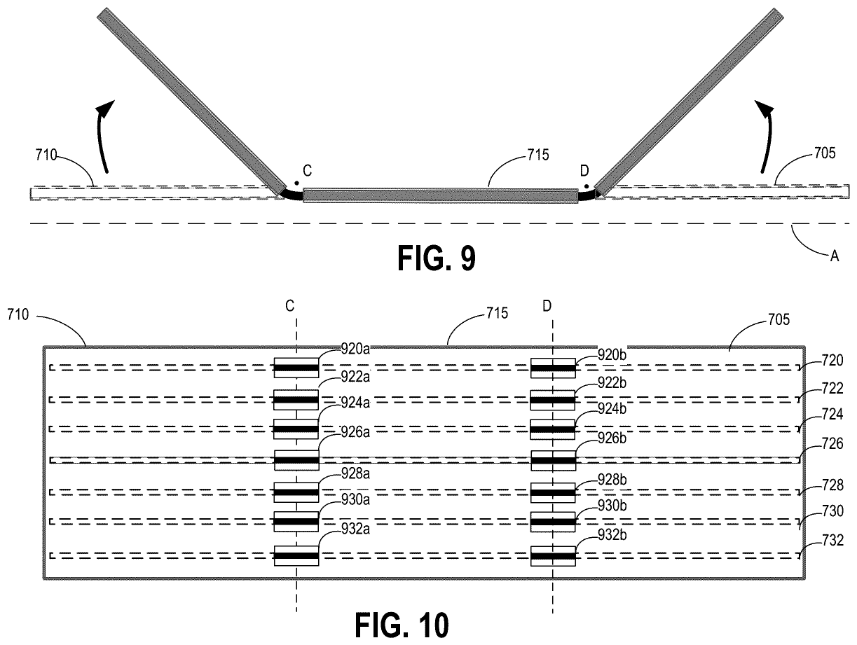

FIG. 8 is a plan view of one embodiment of panels 705, 710, 715 and embedded heat pipes 720-732 which form the radiator structure 700 during one step of the manufacturing process for the radiator structure 700. FIG. 9 is an end view of the panels as indicated in FIG. 8. In FIG. 8, all panels lie flat in a plane “A” as indicated in dashed form (for panels 705 and 710) in FIG. 9. In one aspect, the manufacture of the panels and the heat pipes occurs by first assembling the panels and heat pipes while the panels lie in plane A (FIG. 9), so that all panels and heat pipes in the panels remain planar. This allows manufacturing tolerances of the inner and outer faces of the heat pipes to be more strictly controlled with reduced assembly steps. Although FIG. 8 (and FIG. 10 below) show heat pipes continuously extending between each of the first, second and intermediate panels, in embodiments, heat pipes may extend between the first and intermediate panel, and separately between the second and intermediate panel so as not to be continuous though all three panels. Although FIG. 8 illustrates formation of the panels 705, 710, and 715 in a plane, and the panels comprising planar panels, the technology may be applied to non-planar panels. As such, any of panels 705, 710, 715 may have a non-planar shape. Further, although three panels are described herein, the technology may be applied between two panels and to more than three panels.

The embedded heat pipe panels 705, 710, 715 are constructed from materials such as aluminum. In one embodiment, each embedded heat pipe 720-732 is sandwiched between inner (central body facing) and outer (space facing) faces of panels 705, 710, 715 with a honeycomb core used to separate and support the inner and outer faces The inner and outer faces may be aluminum, copper, graphite or other similar material. The heat pipes may be aluminum stainless steel and/or titanium. In general, more than one heat pipe is used in the construction of a heat pipe panel. The heat pipes in a multiple heat pipe panel may be spaced evenly apart, or staggered, and may be bent or curved to accommodate specific heat removal requirements. The honeycomb core may be aluminum, graphite and/or Kevlar, for example. The inner and outer faces may be secured to the honeycomb core using an adhesive. The heat pipes may be thermally coupled to the inner and outer faces using thermally conductive adhesive, thermally conductive gasket material or traditional epoxy adhesive.

As illustrated in FIG. 8, panels 705, 710, 715 are assembled with gaps 902, 904 exposing portions of the embedded heat pipes, and which allow the panels to be bent about the heat pipe along bend axes “C” and “D” into the configuration shown in FIGS. 7 and 9.

As illustrated in FIG. 9, once the panels 705, 710, 715 are constructed, panels 705 and 710 may be bent at the exposed portion of the embedded heat pipes into the shape shown in FIG. 8 (or other shapes, as required by the particular application). As illustrated in FIG. 7, each panel 705, 710 is bent to an angle α relative to the intermediate panel 715. In embodiments, a may be the same for both panels 705 and 710 or different for each panel, based on the particular application for which the radiator structure is used. In the embodiment of FIG. 7, a is approximately 90 degrees.

FIG. 10 shows an alternative embodiment of panels 705, 710, 715 formed in plane A where a unitary panel structure is utilized. Although the panel is formed of a single structure, the single unitary panel is formed to have a first, a second and an intermediate portion corresponding to the panels 705, 710 and 715, and may further be scored along first bend axis C and second bend axis D. Rather than full length gaps, slits 920a-932a and 920b-932b are formed in at least the inner face of the panel structure to expose portions of the embedded heat pipes 720-732 and allow bending of the panels about axes C and D.

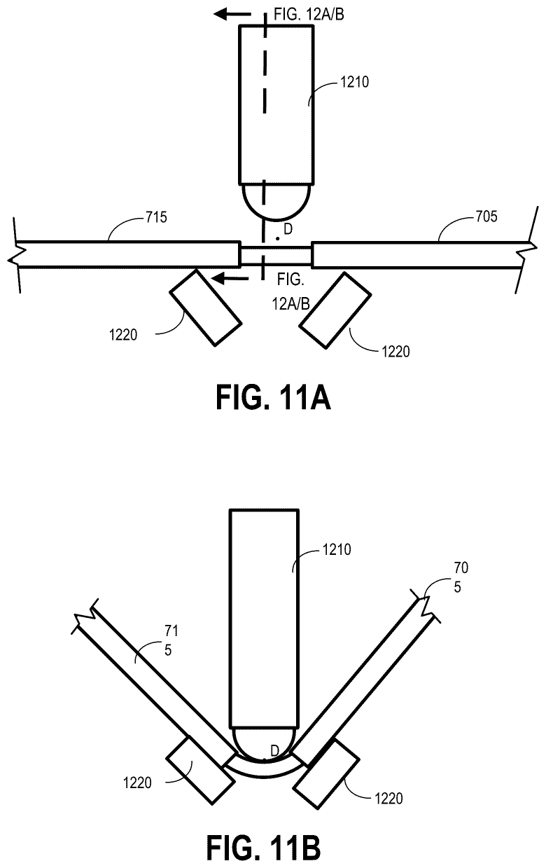

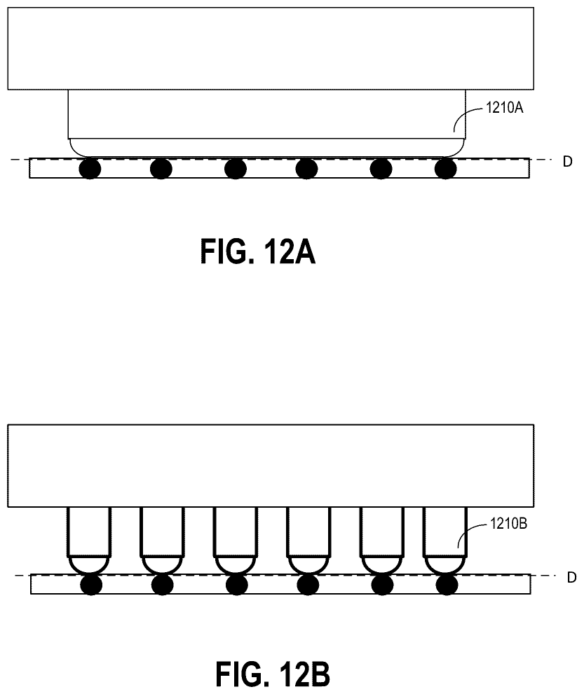

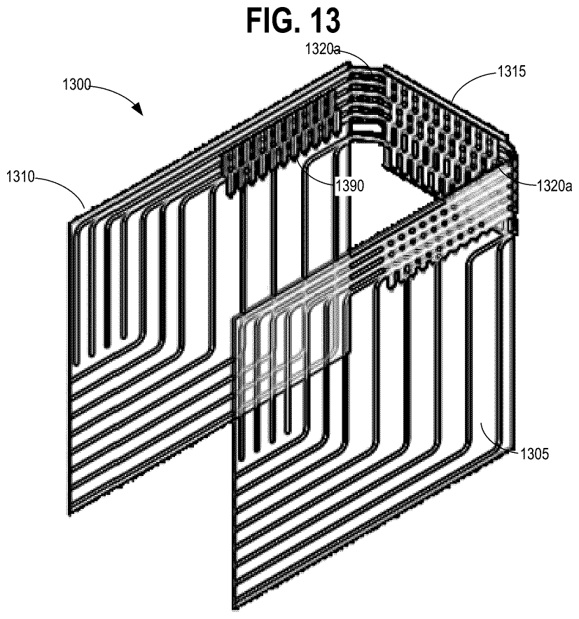

FIGS. 11A and 11B illustrate one method and tool for bending the panels about axis C or D. In one embodiment, a press-brake tool is used for bending the panels around the desired axis at the heat pipe gap or slit. As shown in FIGS. 11A and 11B, a tool 1210 simultaneously clamps the heat pipe(s) (such as all of heat pipes 720-732 so that the panels (705 and 715 in FIGS. 11 and 12) are bent into a die 1220. Tool 1210 is configured to engage the heat pipes through gaps 902, 904, or though slits 920a-932a and 920b-932b. To engage the heat pipes through gaps 902, 904, a tool having a long end effector 1210A as illustrated in FIG. 12A may be used, or individual end effectors 1210B illustrated in FIG. 12B may engage heat pipes 720-732 through slits 920a-932a and 920b-932b. (Individual end effectors 1210B illustrated in FIG. 12B may engage heat pipes 720-732 through gaps 902, 904). Other types of tools and dies can be used.

As noted above, heat pipes can be formed in any number of different configurations when manufactured in a plane (e.g., plane A in FIG. 9). FIG. 13 illustrates another embodiment of a radiator structure 1300 having a first panel 1305, second panel 1310 and intermediate panel 1315, with heat dissipation elements 1320 provided thereon. Notably, the heat pipes 1320 take an L-shaped and S-shaped form within each of the first and second panels and remain straight in the intermediate panel. Intermediate panel 1315 is constructed with a shorter height than the first and second panels. Exposed portions 1320a of the heat pipes are bent and support the connection between the first, second and intermediate panels.

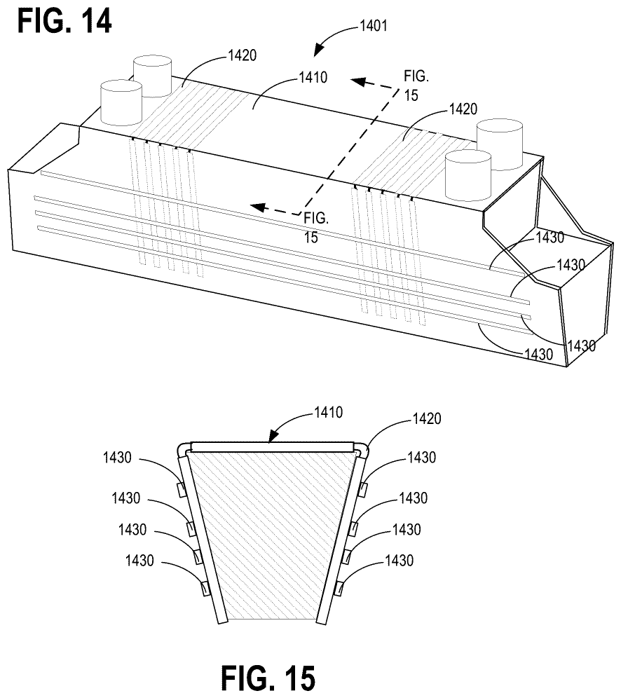

FIG. 14 illustrates another example of a satellite 1401 and FIG. 15 illustrates another radiator system 1410 for that satellite 1401. In this embodiment, the bend angle α between the intermediate and first and second panels need not be ninety degrees. The satellite 1401 of FIG. 14 has a cross-section which is trapezoidal in shape. Thus, the bend at angle α may be greater than or less than 90 degrees. In embodiments, the bend angle α may be between 10 and 170 degrees. The embodiment of FIG. 14 illustrates another feature of a radiator system where embedded heat pipes may be used in conjunction with externally coupled heat pipes. In FIGS. 14 and 15, embedded heat pipes 1420 of a radiator system 1410 (constructed in accordance with the above description) are shown as utilized in conjunction with external, cross-coupled heat pipes 1430. Such externally coupled heat pipes may be used in any of the embodiments described herein.

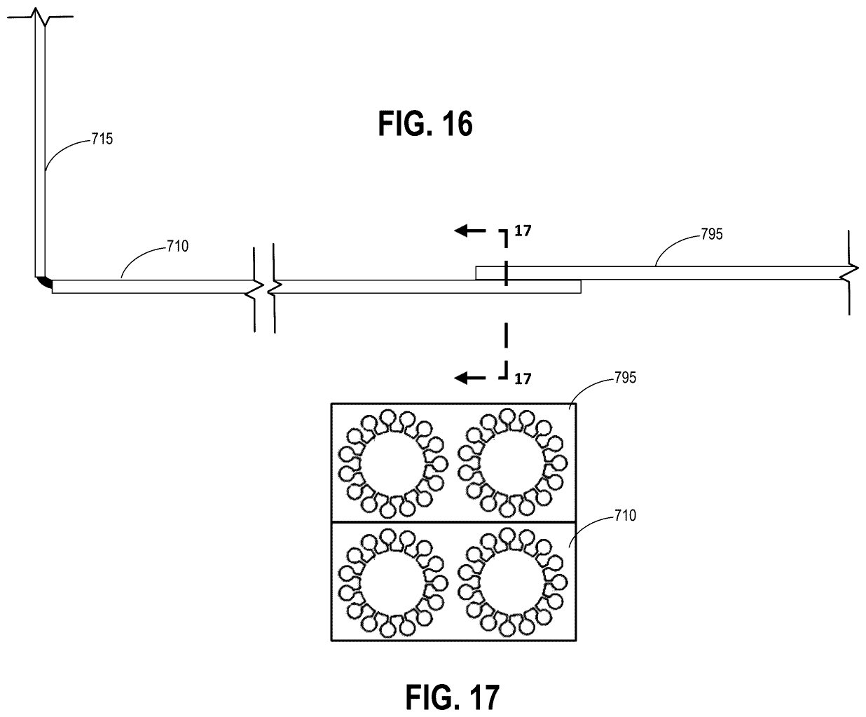

In general, the technology herein may be useful in manufacturing radiator systems where each panel has a length not exceeding approximately 5 meters. In embodiments, in order to extend the length of one panel of a radiator system as described herein, a panel extension as illustrated in FIGS. 16 and 17 may be used. The extension 795 may have the same or a different length than the embedded heat pipe connected panel and may be welded using one of a friction stir or ultrasonic weld techniques, or attached using a conductive adhesive to minimize the resistance to heat transfer between the pipes.

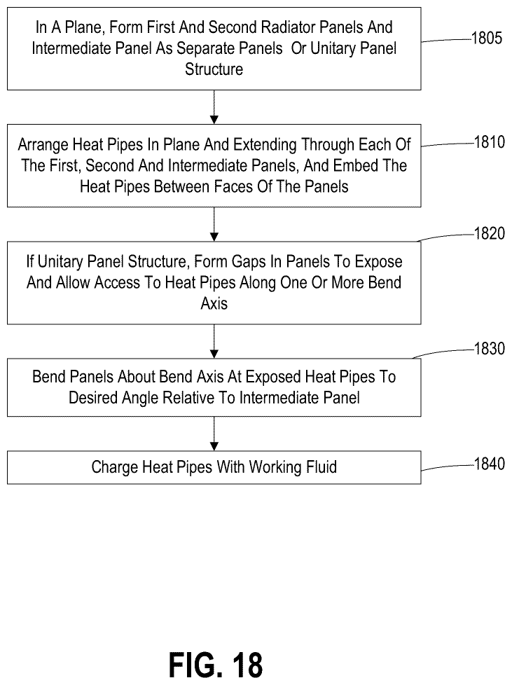

FIG. 18 illustrates a method for manufacturing a radiator structure in accordance with the embodiments described herein. At 1805, first, second and intermediate radiator panels are formed as separate panels (FIG. 8) or as a unitary structure with gapes (FIG. 10). During manufacture, separate panels need not all be formed together but may be placed together at step 1810. At 1810, heat pipes extending between each of the first, second and third intermediate panels are arranged in the panels, and panel assembly is finalized to embed the heat pipes within the panels. As noted above, the heat pipes may be continuous through all three panels or through the intermediate panel and one of the first or second panels, so long as heat pipes extend between the intermediate and adjacent panels. At 1820, optionally, if the panels are formed as a unitary structure (FIG. 10), form gaps in the panels to expose and allow access to embedded heat pipes along one or more bend axis (i.e., axis C and D). At 1830, a tool such as a press brake with an appropriate end effector is used to bend the panels about the bend axis to a desired angle relative to the intermediate panel. At 1840, the heat pipes are charged with a working fluid such as ammonia and are then assembled onto a satellite.

In embodiments, a satellite is provided. The satellite has a first radiator panel on a first side of a central body of the satellite, and a second radiator panel on a second side of the central body. The satellite also includes each of the first and second radiator panel including at least one heat pipe embedded between a first face and a second face of each panel and structurally supporting the first radiator panel relative to the second radiator.

The satellite may include an embodiment of the satellite where the first radiator panel and second radiator panel are planar and are arranged at an angle relative to each other, the angle formed by a portion of the at least one heat pipe between the first radiator panel and the second radiator panel. The satellite may include a satellite of any of the foregoing embodiments further including a third radiator panel positioned on a third side of the central body wherein the second radiator panel comprises an intermediate radiator panel between the first and third panels, and wherein the at least one heat pipe is at least one continuous heat pipe extending between the first, second and third radiator panels. The satellite may include a satellite of any of the foregoing embodiments where at least one heat pipe may include at least a first heat pipe extending from the first radiator panel into the second radiator panel, and at least a second heat pipe extending from the second radiator panel into the third radiator panel The satellite may include a satellite of any of the foregoing embodiments where including a plurality of continuous heat pipes extending between and embedded in the first, second and third radiator panels. The satellite may include a satellite of any of the foregoing embodiments where the at least one heat pipe includes a first exposed portion between the first radiator panel and the second radiator panel. The satellite may include a satellite of any of the foregoing embodiments where the at least one heat pipe is at least one continuous heat pipe and includes a first exposed portion between the first radiator panel and the second panel, and a second exposed portion between the second radiator panel and the third radiator panel. The satellite may include a satellite of any of the foregoing embodiments where the first radiator panel and second radiator panel are planar and are arranged at an angle relative to the intermediate panel and the angle is between 10 and 170 degrees. The satellite may include a satellite of any of the foregoing embodiments wherein at least one of the first radiator panel and the second radiator panel are non-planar.

One general aspect includes an apparatus comprising a radiator structure. A first radiator panel adapted to be positioned on a first side of a central body, a second radiator panel adapted to be positioned on a second side of the central body, and an intermediate radiator panel positioned between the first panel and the second panel. The apparatus also includes at least one heat pipe embedded between a first face and a second face of each radiator panel and extending from the first radiator panel through the intermediate radiator panel and through the second radiator panel. The at least one heat pipe structurally supports the first radiator panel and the second radiator panel relative to the intermediate radiator panel.

The apparatus may include any foregoing embodiment where the first radiator panel and second radiator panel are planar and are arranged at an angle relative to the intermediate panel, the angle formed by a first exposed portion of the at least one heat pipe between the first radiator panel and the intermediate panel, and a second exposed portion between the second radiator panel and the intermediate panel. The apparatus may include any foregoing embodiment where at least one heat pipe may include a plurality of continuous heat pipes extending between and embedded in the first, second and intermediate radiator panels. The apparatus may include any foregoing embodiment where the first radiator panel and second radiator panel are planar and are arranged at an angle relative to the intermediate panel, the angle formed by a portion of the at least one heat pipe in the first exposed portion between the first radiator panel and the intermediate panel, and in the second exposed portion between the second radiator panel and the intermediate panel. The apparatus may include any of the foregoing embodiments wherein at least one of the first radiator panel and the second radiator panel are non-planar.

Another aspect includes a method of manufacturing a satellite radiator structure. The method includes forming a first radiator panel and a second radiator panel. The method also includes embedding one or more heat pipes between the first radiator panel and the second radiator panel. The method also includes bending the first radiator panel at a first angle relative to the second radiator panel about a first bend axis in a first exposed portion of the one or more heat pipes. The method also includes charging the heat pipes with a working fluid.

Implementations may include the foregoing method further including forming a third radiator panel; and bending the second radiator panel at a second angle relative to the third radiator panel about a second bend axis in a second exposed portion of the one or more heat pipes. Implementations may include the foregoing methods where forming may include forming a single unitary panel having a first, a second and a third portion, the unitary panel having first and second bend axes; forming gaps in the unitary panel to expose the first and second exposed portions. Implementations may include any of the foregoing methods where the forming may include: forming the first radiator panel, the second radiator panel and the third radiator panel in the plane; positioning the first radiator panel adjacent to the second radiator panel on a first side of the intermediate radiator panel, and the second radiator panel adjacent to the third radiator panel on an opposing side of the second radiator panel; arranging the one or more heat pipes to extend from the first radiator panel through the second radiator panel and into the third radiator panel, leaving the first exposed portion between the first radiator panel and the second radiator panel, and the second exposed portion between the second radiator panel and the third radiator panel. The bending may include bending using a press brake tool. Implementations may include any of the foregoing methods where the one or more heat pipes may include a plurality of heat pipes and the bending may include bending the plurality of the heat pipes between the first radiator panel and the intermediate radiator panel simultaneously and bending the heat pipes between the second radiator panel and the intermediate radiator panel simultaneously.

For the purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For the purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate thermally between them.

For purposes of this document, the term “based on” may be read as “based at least in part on.”

For purposes of this document, without additional context, use of numerical terms such as a “first” object, a “second” object, and a “third” object may not imply an ordering of objects but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of be defined by the claims appended hereto.

What is claimed is:

1. A satellite comprising:
a first radiator panel on a first side of a central body of the satellite;
a second radiator panel on a second side of the central body; and
at least one heat pipe embedded between a first face and a second face of each of the first and second radiator panel and structurally supporting the first radiator panel relative to the second radiator panel.

2. The satellite of claim 1 wherein the first radiator panel and second radiator panel are planar and are arranged at an angle relative to each other, the angle formed by a portion of the at least one heat pipe between the first radiator panel and the second radiator panel.

3. The satellite of claim 1 further including a third radiator panel positioned on a third side of the central body, wherein the second radiator panel comprises an intermediate radiator panel between the first and third radiator panels, and wherein the at least one heat pipe is at least one continuous heat pipe extending between the first, second and third radiator panels.

4. The satellite of claim 3 wherein the at least one heat pipe comprises at least a first heat pipe extending from the first radiator panel into the second radiator panel, and at least a second heat pipe extending from the second radiator panel into the third radiator panel

5. The satellite of claim 3 wherein the at least one heat pipe comprises a plurality of continuous heat pipes extending between and embedded in the first, second and third radiator panels.

6. The satellite of claim 1 wherein the at least one heat pipe includes a first exposed portion between the first radiator panel and the second radiator panel.

7. The satellite of claim 1 wherein the at least one heat pipe is at least one continuous heath pipe and includes a first exposed portion between the first radiator panel and the second radiator panel, and a second exposed portion between the second radiator panel and a third radiator panel.

8. The satellite of claim 1 wherein at least one of the first radiator panel and the second radiator panel are non-planar.

9. The satellite of claim 2 wherein the angle formed by a portion of at least one heat pipe is in a range of 10 to 170 degrees.

10. An radiator structure, comprising:
a first radiator panel adapted to couple to a first side of a central body;
a second radiator panel adapted to couple to a second side of the central body; and
an intermediate radiator panel positioned between the first radiator panel and the second radiator panel;
at least one heat pipe embedded between a first face and a second face of each radiator panel and extending from the first radiator panel through the intermediate radiator panel and through the second radiator panel, the at least one heat pipe structurally supporting the first radiator panel and the second radiator panel relative to the intermediate radiator panel.

11. The structure of claim 10 wherein the first radiator panel and second radiator panel are planar and are arranged at an angle relative to the intermediate panel, the angle formed by a first exposed portion of the at least one heat pipe between the first radiator panel and the intermediate panel, and a second exposed portion between the second radiator panel and the intermediate panel.

12. The structure of claim 11 wherein the at least one heat pipe comprises a plurality of continuous heat pipes extending between and embedded in the first, second and intermediate radiator panels.

13. The structure of claim 11 wherein the first radiator panel and second radiator panel are planar and are arranged at an angle relative to the intermediate panel, the angle formed by a portion of the at least one heat pipe in the first exposed portion between the first radiator panel and the intermediate panel, and in the second exposed portion between the second radiator panel and the intermediate panel.

14. The structure of claim 10 wherein at least one of the first radiator panel and the second radiator panel are non-planar.

15. A method of manufacturing a satellite radiator structure, comprising:
forming a first radiator panel, and a second radiator panel;
embedding one or more heat pipes between the first radiator panel and the second radiator panel;
bending the first radiator panel at a first angle relative to the second radiator panel about a first bend axis in a first exposed portion of the one or more heat pipes;
and
charging the heat pipes with a working fluid.

16. The method of claim 15 further including
forming a third radiator panel; and
bending the second radiator panel at a second angle relative to the third radiator panel about a second bend axis in a second exposed portion of the one or more heat pipes.

17. The method of claim 16 wherein forming comprises:
forming a single unitary panel having a first, a second and an third portion, the unitary panel having first and second bend axes;
forming gaps in the unitary panel to expose the first and second exposed portions.

18. The method of claim 16 wherein forming comprises:
forming the first radiator panel, the second radiator panel and the third radiator panel in a plane;
positioning the first radiator panel adjacent to the second radiator panel on a first side of the second radiator panel, and the second radiator panel adjacent to the third radiator panel on an opposing side of the second radiator panel;
arranging the one or more heat pipes to extend from the first radiator panel through the second radiator panel and into the third radiator panel, leaving the first exposed portion between the first radiator panel and the second radiator panel, and the second exposed portion between the second radiator panel and the third radiator panel.

19. The method of claim 15 wherein the bending comprises bending using a press brake tool.

20. The method of claim 16 wherein the one or more heat pipes comprises a plurality of heat pipes and the bending comprises bending the plurality of the heat pipes between the first radiator panel and the second radiator panel simultaneously, and bending the heat pipes between the second radiator panel and the third radiator panel simultaneously.
